(19) United States
(12) Patent Application Publication
(10) Pub. No.: US 2012/0023562 A1
(43) Pub. Date: Jan. 26, 2012

(54) SYSTEMS AND METHODS TO ROUTE NETWORK COMMUNICATIONS FOR NETWORK-BASED SERVICES

(76) Inventors: David Harp, Plano, TX (US); Toby Bearden, McKinney, TX (US); Jason Matthew Godfrey, Volcano, CA (US)

(21) Appl. No.: 12/843,732

(22) Filed: Jul. 26, 2010

(51) Int. Cl. G06F 15/16; G06F 15/173; G06F 21/20

(52) U.S. Cl. 726/7; 709/230; 709/223

(57) ABSTRACT

Example systems and methods to route network communications for network-based services are disclosed. An example method includes receiving network communications; determining if at least one of a source address or a destination address of the received network communications is associated with a customer to receive a network-based service; forwarding the network communications to a policy enforcement point if the at least one of the source address or the destination address is associated with the customer; determining if the forwarded network communications violates a policy selectively associated with the customer; and forwarding the network communications from the policy enforcement point to the destination address if the network communications is not in violation of the policy.

### TECHNICAL FIELD

The present disclosure pertains to routing network communications and, more specifically, to systems and methods to route network communications for network-based services.

### BACKGROUND

Internet Service Provider (ISP) networks support a wide variety of customers with varying service needs. To enhance customer satisfaction, in addition to providing internet service, the ISP may provide additional services to their customer(s) to enhance customer relations. These additional services may be implemented by software that customers of the ISP may download and execute on their local equipment. Alternatively, the additional services may be network-based, such that the ISP monitors network traffic or communications to and/or from the customer equipment to perform the additional services.

### BRIEF DESCRIPTION OF THE DRAWINGS

FIG. 1 illustrates an example manner of implementing a system to route network traffic or communications for network-based services.

FIG. 2 illustrates an example manner of implementing the policy enforcement point of FIG. 1.

FIG. 3 illustrates an example manner of implementing the policy enforcement access point of FIG. 1.

FIG. 4 is a flowchart representative of example machine-readable instructions that may be executed to implement the example policy enforcement access point of FIGS. 1 and 3.

FIG. 5 is a flowchart representative of example machine-readable instructions that may be executed to implement the example policy enforcement access point of FIGS. 1 and 3.

FIG. 6 is a flowchart representative of example machine-readable instructions that may be executed to implement the example policy enforcement point of FIGS. 1 and 2.

FIG. 7 is a block diagram of an example processor system that may execute, for example, the machine-readable instructions of FIGS. 4 through 6 to implement the example policy enforcement access point of FIGS. 1 and 3, and/or the example policy enforcement point of FIGS. 1 and 2.

### DETAILED DESCRIPTION

Network-based services are typically offered as a value-added service from an Internet Service Provider (ISP). One particular network-based service that an ISP may offer is a network-based security service. Network-based security services reduce the likelihood of the customers receiving unwanted or inappropriate content via the ISP. An example network-based security service is a firewall that prevents network communications matching a specific profile from being transmitted to the customer. Another example network-based security service is an antivirus gateway, which inspects network traffic or communications to identify network communications potentially containing computer viruses before the communications are transmitted to the customer. While network-based security services are described herein, the example methods and apparatus may be more generally applied for use with other network-based services such as, for example, quality of service (QoS) services, location based services, virtual private network (VPN) services, etc.

Some ISPs may provide network-based services without requesting consent from their customers (e.g., an opt-out service), while other ISPs may request consent from their customers before providing network-based services (e.g., an opt-in service). Under either scenario, there may be a percentage of subscribers who do not wish to receive the service. The percentage of subscribers who are receiving the services versus those who are not receiving the services is commonly known as the take rate.

An example network of an ISP comprises many individual pieces of network equipment. The network equipment may be organized such that subscribers are provided network service by an edge device of the network such as a router or a switch. There may be additional components internal to the network that handle network traffic or communications to route the communications to the proper destination. Edge devices may be contained in edge sites near customer premises to achieve a greater signal strength between the customer equipment and the edge device.

Providing network-based services requires one or more network elements, points, and/or nodes in the ISP's network to serve as policy enforcement points. The policy enforcement point(s) may comprise firewalls, filters, gateways, etc. to prevent, block, or delay the transmission of unwanted, inappropriate, or malicious content. One particular method of providing services to customers of the ISP may include establishing a policy enforcement point at each edge site to provide network-based services to all of the customers utilizing the edge site. However, because take rates for network-based services typically represent a small percentage of the customers of the ISP (e.g., one percent to ten percent), implementing a policy enforcement point at each edge site is not desirable because of additional cost of implementation and the expected underutilization of the equipment.

Alternatively, the ISP may implement the policy enforcement point at a different point within the network. However, to service the customers who are to receive network-based services, the ISP must be able to properly and efficiently route and/or steer network traffic or communications for those customers to at least one policy enforcement point within the network.

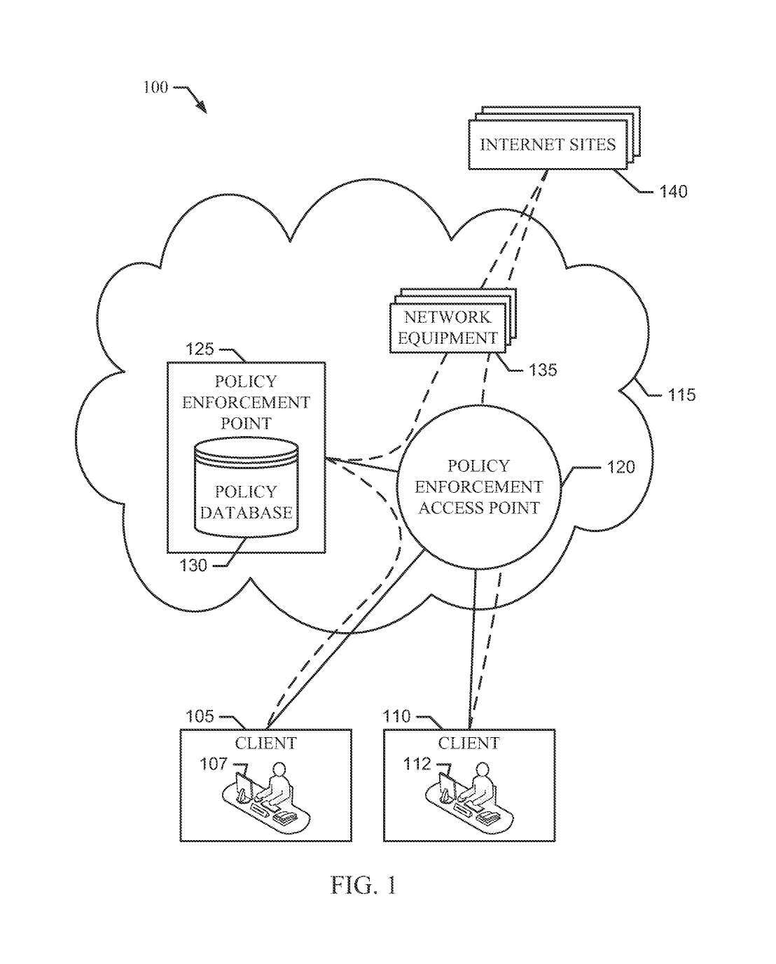

FIG. 1 illustrates an example manner of implementing a system 100 to route and/or steer network traffic or communications for network-based services. The example system 100 comprises a first client 105, a second client 110, an access network 115, and interne sites 140. The access network 115 comprises a policy enforcement access point 120, a policy enforcement point 125, a policy database 130, and network equipment 135. In this example, the first client 105 is associated with a first customer 107, and the second client 110 is associated with a second customer 112. In the examples illustrated herein, the network-based services are security services. However, any other services may additionally or alternatively be provided.

In the illustrated example, the first client 105 receives a network-based security service, and the second client 110 does not receive the network-based security service. The first and second clients 105, 110 represent the respective customers 107, 112 of the ISP. While in the example of FIG. 1 two clients are displayed, any number of clients may be used. For example, an ISP may have hundreds or thousands of customers 107, 112, each of which may operate one or more clients 105, 110. Further, while the proportion of customers receiving network-based security services (e.g., the first customer 107) to clients not receiving network-based security services (e.g., the second customer 112) is equal in the illustrated example, any other proportion may be used.

In the illustrated example, the customers 107, 112 and their respective clients 105, 110 have selected whether to receive network-based security services via an opt-in program. For example, when network-based security services were initiated, the customers 107, 112 were asked whether they would like to receive network-based security services. The customers 107, 112 may be asked in any fashion. For example, the customers 107, 112 may be sent an email, be directed to a website, asked to participate during a telephone call, or be contacted by postal mail (e.g., a brochure or a flyer). In the illustrated example, the customers 107, 112 are presumed to not want to receive the services unless they ask to participate in the program. However, in other examples, the customers 107, 112 may be presumed to want to receive the services unless they ask to not participate in the program.

In the illustrated example, the network 115 is an internet protocol (IP) based network, however any other type of network may alternatively be used. The network 115 of the illustrated example provides broadband services to the clients 105, 110. The broadband service of FIG. 1 is provided via a Digital Subscriber Line (DSL). However, the broadband service may be provided by any other means such as, for example, a cellular network, a cable connection, a satellite connection, etc.

In an IP-based network, each device on the network is assigned a unique IP address. In the illustrated example, IP version 4 (IPv4) addresses are used. However, any other addressing scheme may additionally or alternatively be used such as, for example, IP version 6, etc.

The policy enforcement access point 120 of FIG. 1 functions as a router. The policy enforcement access point 120 receives requests for IP addresses from the clients 105, 110 and routes network traffic or communications to and/or from the clients 105, 110. In the illustrated example, the policy enforcement access point 120 distributes IP addresses to the clients by a dynamic host configuration protocol (DHCP). However, any other means of issuing IP addresses to clients may additionally or alternatively be used such as, for example, static IP assignments may be used. Upon receiving the request for an IP address, the policy enforcement access point 120 may request additional credentials from the clients 105, 110 to assist in determining whether they are to receive network-based security services. Such additional credentials may be a username and password, a serial number associated with the clients 105, 110 such as a media access control (MAC) address, or any other identifier that uniquely identifies the clients 105, 110.

When issuing an IP address to the clients 105, 110, the policy enforcement access point 120 may query a database such as the policy database 130 with the credentials provided by the clients 105, 110 to determine whether they are to receive network-based security services. In particular, an IP address within a specific subnet of customers receiving network-based security services may be issued to clients that are to receive network-based security services. In the illustrated example, the first client 105 is configured to receive network-based security services and, therefore, receives an IP address within a first subnet (e.g., the 192.168.1.0/25 IP address range). The second client 110 is configured to not receive network-based security services, and therefore, receives an IP address within a second subnet (e.g., the 192.168.1.128/25 IP address range). While in the illustrated example, two subnets starting with 192.168.1 and comprised of 128 hosts are shown, any size subnets starting with any IP address may be used. Further, while the example shown in FIG. 1 shows subnets that are statically allocated (e.g., 192.168.1.0/25 and 192.168.1.128/25), subnets may be allocated in any other fashion. For example, subnets may be dynamically assigned based on the number of customers who have agreed to receive network-based services. Additionally, there may be more than one subnet configured for participation in network-based services. For example, the subnets 192.168.1.0/25 and 192.168.2.128/25 may be allocated for network-based services.

While in the illustrated example the policy enforcement access point 120 issues IP address to clients, this role may additionally or alternatively be performed by any other suitable device such as, for example, a router, DHCP server, etc.

In addition to issuing IP addresses to the clients 105, 110, the policy enforcement access point 120 acts as an access point for the policy enforcement system. The policy enforcement access point 120 receives network traffic or communications destined to or coming from the clients 105, 110. After receiving the traffic or communications, the policy enforcement access point 120 determines whether either the source or destination IP address of the communications are within the subnet(s) configured to receive network-based services. If either the source or destination IP address of the communications are within the subnet(s) configured to receive network-based services, then the communications is forwarded to the policy enforcement point 125. If neither the source nor destination IP address of the communications is within the subnet(s) that is configured to receive network-based services, then the communications are forwarded to the destination address.

The policy enforcement point 125 receives the network communications from the policy enforcement access point 120. While in the illustrated example, the policy enforcement point 125 is shown as a separate piece of hardware associated with the policy enforcement access point 120, the policy enforcement point 125 may be associated with multiple policy enforcement access points 120. For example, there may be ten policy enforcement access 120 points associated with a single policy enforcement point 125. Further, there may be any number of policy enforcement points 125. In an example network, there may be one hundred policy enforcement access points 120 and ten policy enforcement points 125. In such an example, the policy enforcement points 125 may be associated with any number of subnets, and network communications associated with subnets that are to receive network-based security services may be forwarded to any policy enforcement point 125. Alternatively, certain policy enforcement points 125 may be associated with a specific subnet or set of subnets.

The policy enforcement point 125 determines which IP address is the address of the client 105 and queries the policy database 130 to determine what type of policy to implement for that particular IP address. There may be any number of policies that may be implemented by the policy enforcement point 125, and the policies may vary in type and/or scope. For example, the policies may include one or more security policies. In such security policies, there may be a first security policy designed for parents wanting to protect their children from explicit material, and a second security policy designed to prevent viruses and/or malware from infecting the clients utilizing the network-based security service. Additionally or alternatively, non-security type policies may be included such as, for example a quality of service (QoS) policy that prioritizes particular types of traffic for a customer.

In the illustrated example, the various security policies are pre-configured. However, the security policies may be user configurable so that customers can select which security policy(ies) to apply, or restrict access to specific internet resources. Additionally or alternatively, the security policies may be managed by a security policy manager such as the ISP or a third party (e.g., a company specializing in internet security policies). For example, the security policy manager may update security policies in accordance with new threats to security present on the Internet.

Once the policy enforcement point 125 has determined the security policy(ies) to apply to the network communications, the policy enforcement point 125 applies the policy(ies) and determines if the communications are in violation of the policy(ies). If the network communications do not violate the policy(ies), the communications are forwarded to the destination. If the network communications violate the policy(ies), the communications are not forwarded to the destination. Alternatively, the policy(ies) may comprise a non-security type policy (such as a QoS policy), where the network communications not in violation of the policy are prioritized while the network communications in violation of the policy are delayed.

The policy database 130 of FIG. 1 is local to the policy enforcement point 125. However, the policy database 130 could be located at any point in the network 115. Further, the policy database 130 may be distributed among multiple pieces of network equipment 135. For example, the policy database 130 may be implemented at a policy server remote from the policy enforcement point 125. In such an example, the policy server may store a comprehensive policy database 130, while individual policy enforcement points 125 may store a condensed policy database 130. The condensed policy database 130 may contain policies and/or settings for a specific subnet or set of subnets serviced by the policy enforcement point.

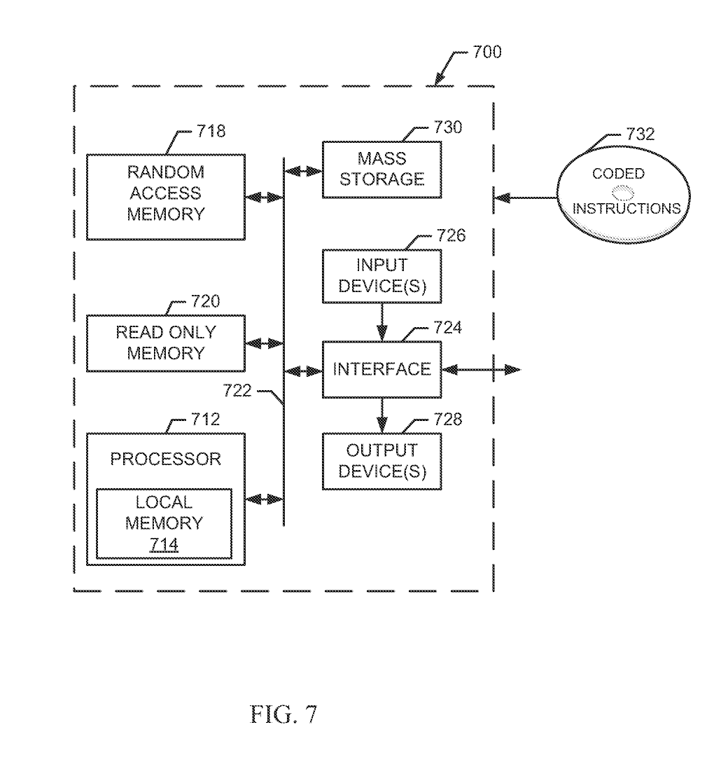

The policy database 130 may be any type of database. In the example implementation shown in FIG. 1, the policy database 130 is a database on a mass storage device 730 (see FIG. 7). The database 130 may be implemented as any type of database such as, for example, a flat file database (e.g., a Comma Separated Value (CSV) file), a relational database (e.g., SQL), etc.

The policy database 130 may contain any type of information related to performing network-based services such as, for example, customers and/or clients requesting the services, policies, customer configurations, etc. Additionally or alternatively, different types of information may be stored in different locations. For example, a list of customers may be stored in the comprehensive policy database 130, while individual customer configurations may be stored in the condensed policy database 130.

As a further example, the policy database 130 may be stored on a policy server and may be periodically propagated to the policy enforcement point(s) 125. In such an example, customers may configure their particular settings (e.g., whether to receive network-based security services, which policy(ies) to apply, etc.) at the policy server via, for example, a website. However, any other method of configuring options may also be used such as, for example, calling an operator, sending an email or short message service (SMS) message, using a standalone application, etc. The settings are then stored at the policy server, and the policy database 130 is replicated to each policy enforcement point 125 on a periodic basis (e.g., hourly, daily, weekly, etc.) The policy enforcement point 125 then consults the local policy database, which is at most one period old (e.g., one hour, one day, one week, etc.).

The network equipment 135 of FIG. 1 includes routing equipment and may additionally include gateways, physical mediums such as cabling, servers such as the policy server, additional policy enforcement points 125, additional policy enforcement access points 120, etc. There may be any number of additional network equipment 135, and the network equipment 135 may be physically located in any location, whether local or remote from the policy enforcement point 125 and/or the policy enforcement access point 120.

The internet sites 140 of FIG. 1 are content providing sites. In the illustrated example, the internet sites 140 host webpages that are accessible to the clients 105, 110 via the network. The customers 107, 112 view the webpages via browsers on the clients 105, 110. While many internet sites 140 may be legitimate and of interest to the customers 107, 112, some internet sites 140 may present malicious or unwanted content to the customers. The interne sites 140 may comprise any number of sites and may include clients 105, 110. For example, the client 105, 110 may be a content providing site. The client 105 may configure network-based security services to prevent malicious attacks against the client 105 (e.g., denial of service, site scanning, site reconnaissance, etc.)

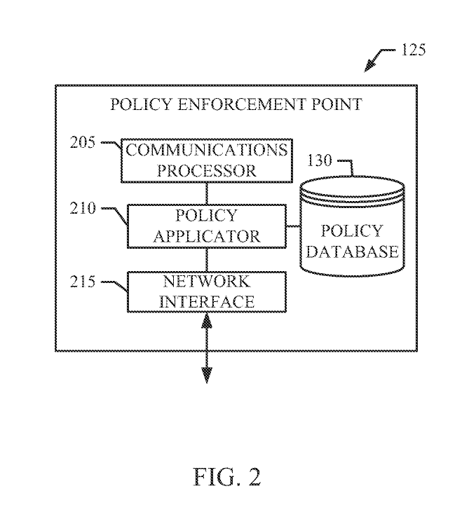

FIG. 2 illustrates an example manner of implementing the policy enforcement point 125 of FIG. 1. The example policy enforcement point 125 comprises a communications processor 205, a policy applicator 210, the policy database 130, and a network interface 215.

The communications processor 205 of FIG. 2 receives network traffic or communications from the network interface 215 and prepares the network communications for application of a policy. Such preparation may include unpacking Hypertext Transfer Protocol (HTTP) messages to expose the contents of the messages. While in the illustrated example the communications processor 205 ignores communications not using HTTP, the communications processor 205 may additionally or alternatively inspect network communications using other protocols such as, for example, file transfer protocol (FTP), post office protocol (POP), simple mail transfer protocol (SMTP), etc. The communications processor 205 also inspects the network communications to determine the IP address of the client (e.g., the IP address of the client may be either the source IP address or the destination address).

The policy applicator 210 of FIG. 2 retrieves the policy from the policy database 130 based on the IP address of the client (as determined by the communications processor 205). While the IP address of the client uniquely identifies the client, the policy applicator 210 also queries the policy database 130 to determine which customer is associated with the client, and then determines the correct policy(ies) to apply based on that customer's preferences. For example, the preferences of the first customer 107 may be different from the preferences of the second customer 112.

The network interface 215 of FIG. 2 allows the policy enforcement point 125 to communicate with other devices within the network 115. In the illustrated example, an IEEE 802.3 wired Ethernet network interface is used. However, any other network interface may additionally or alternatively be used such as, for example, an IEEE 802.11x wireless network, an 802.15 ZigBee wireless network, an optical network interface, etc. Regardless of the type of network interface 215 that is utilized in the policy enforcement point 125, the network interface 215 enables communication with the network 115, the policy enforcement access point 120, the clients 105, 110, the network equipment 135, and the interne sites 140.

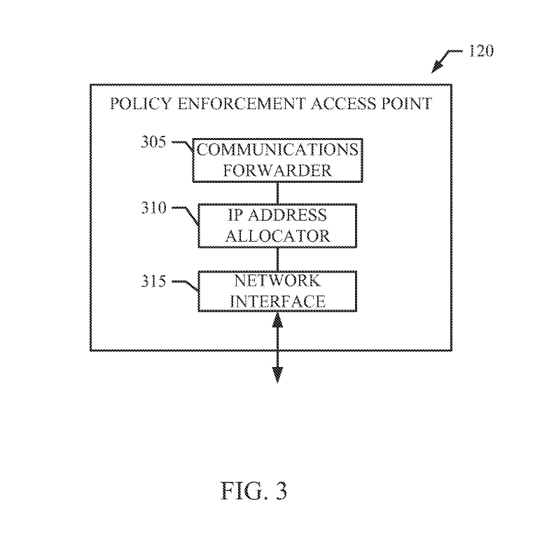

FIG. 3 illustrates an example manner of implementing the policy enforcement access point 120 of FIG. 1. The example policy enforcement access point 120 comprises a communications forwarder 305, an IP address allocator 310, and a network interface 315.

The communications forwarder 305 of FIG. 3 receives network communications or communications from the network interface 315 and determines if the communications should be forwarded to its destination or to the policy enforcement point 125. The communications forwarder 305 determines if the communications should be forwarded to its destination or to the policy enforcement point 125 by determining if either the source or destination IP address of the network communications are within the subnet or group of subnets configured to receive network-based services. If either the source or destination IP address of the network communications are within the subnet or group of subnets configured to receive network-based services, the communications forwarder 305 forwards the network communications to the policy enforcement point 125, otherwise the network communications are forwarded to the destination. Additionally, the communications forwarder 305 may inspect the communications to determine if a policy is applicable. For example, policies may not be applicable if the network communications are on a given port (e.g., a port for email, a port for FTP communications, etc.)

The IP address allocator 310 of FIG. 3 receives requests for IP addresses from the clients 105, 110 and allocates IP addresses to the clients 105, 110. In the illustrated example, the IP address allocator 310 distributes IP addresses to the clients via Dynamic Host Configuration Protocol (DHCP). However, any other means of issuing IP addresses to clients may additionally or alternatively be used such as, for example, static IP assignments. Upon receiving a request for an IP address, the IP address allocator 310 may request additional credentials from the clients 105, 110 to assist in determining whether they are to receive network-based services. Such additional credentials may be a username and password, a serial number associated with the clients 105, 110 such as a media access control (MAC) address, or any other identifier that uniquely identifies the clients 105, 110. The IP address allocator 310 uses the credentials to determine if the client 105, 110 should be allocated an IP address within the subnet or group of subnets that are to receive network-based services.

Multiple network-based services may be provided by the ISP. For example, the ISP may provide a network-based security service as well as a network-based QoS service. In such an example, customers receiving neither of the services may be allocated IP addresses within in a first subnet, customers receiving only the network-based security service may be allocated IP addresses within a second subnet, customers receiving only the network-based QoS service may be allocated IP addresses within a third subnet, and customers receiving both the network-based security service and network-based QoS service may be allocated IP addresses within a fourth subnet. The subnets may be dynamically allocated to reflect the number of customers receiving each network-based service.

The network interface 315 of FIG. 3 allows the policy enforcement access point 120 to communicate with other devices within the network 115. In the illustrated example, an IEEE 802.3 wired Ethernet network interface is used. However, any alternative network interface may additionally or alternatively used such as, for example, an IEEE 802.11x wireless network, an 802.15 ZigBee wireless network, an optical network interface, etc. Regardless of the type of network interface 315 that is utilized in the policy enforcement access point 120, the network interface 315 enables communication with the network 115, the policy enforcement point 125, the clients 105, 110, the network equipment 135, and the interne sites 140.

While an example manner of implementing the policy enforcement point 125 of FIGS. 1 and 2 and the policy enforcement access point 120 of FIGS. 1 and 3 have been described, one or more of the elements, processes and/or devices illustrated in FIGS. 1 through 3 may be combined, divided, re-arranged, omitted, eliminated and/or implemented in any other way. Further, the example communications processor 205, the example policy applicator 210, the example network interface 215, the example policy database 130, and/or more generally, the example policy enforcement point 125; and/or the example communications forwarder 305, the example IP address allocator 310, the example network interface 215, and/or, more generally, the example policy enforcement access point 120 may be implemented by hardware, software, firmware and/or any combination of hardware, software and/or firmware. Thus, for example, any of the example communications processor 205, the example policy applicator 210, the example network interface 215, the example policy database 130, and/or more generally, the example policy enforcement point 125; and/or the example communications forwarder 305, the example IP address allocator 310, the example network interface 215, and/or, more generally the example policy enforcement access point 120 could be implemented by one or more circuit(s), programmable processor(s), application specific integrated circuit(s) (ASIC(s)), programmable logic device(s) (PLD(s)) and/or field programmable logic device(s) (FPLD(s)), etc.

When any of the appended apparatus claims are read to cover a purely software and/or firmware implementation, at least one of the example communications processor 205, the example policy applicator 210, the example network interface 215, the example security policy database 130, and/or, more generally, the example policy enforcement point 125; and/or the example communications forwarder 305, the example IP address allocator 310, the example network interface 215, and/or more generally the example policy enforcement access point 120 are hereby expressly defined to include a computer readable medium such as a memory, DVD, CD, etc. storing the software and/or firmware. Further still, the example policy enforcement point 125 and/or the policy enforcement access point 120 may include one or more elements, processes and/or devices in addition to, or instead of, those illustrated in FIGS. 2 and 3, and/or may include more than one of any or all of the illustrated elements, processes, and devices.

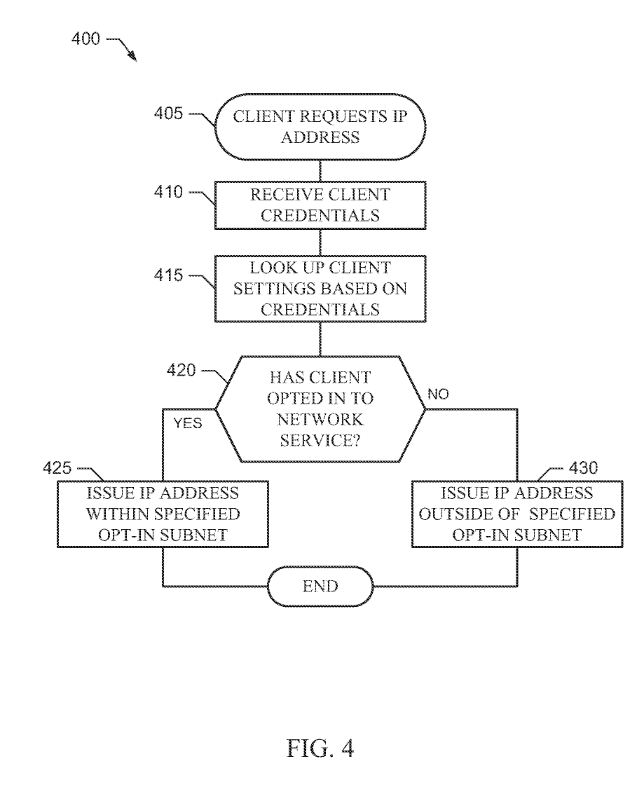

Flowcharts representative of example machine-readable instructions for implementing the example policy enforcement point 125 of FIGS. 1 and 2, and/or the example policy enforcement access point 120 of FIGS. 1 and 3 are shown in FIGS. 4 through 6. In these examples, the machine readable instructions comprise a program for execution by a processor such as the processor 712 shown in the example computer 700 discussed below in connection with FIG. 7. The program may be embodied in software stored on a computer readable medium such as a CD-ROM, a floppy disk, a hard drive, a digital versatile disk (DVD), or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 4 through 6, many other methods of implementing the example policy enforcement point 125 of FIGS. 1 and 2, and/or the example policy enforcement access point 120 of FIGS. 1 and 3 may alternatively be used. For example, the order of execution of the blocks may be changed, and/or some of the blocks described may be changed, eliminated, or combined.

As mentioned above, the example processes of FIGS. 4 through 6 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 4 through 6 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 4 is a flowchart representative of example machine-readable instructions 400 that may be executed to implement the example policy enforcement access point 120 of FIGS. 1 and 3. The machine readable instructions 400 begin execution when the client 105, 110 requests an IP address from the network (block 405). The request from the client 105, 110 is typically implemented in the form of a DHCP request message, however any other type of request message may additionally or alternatively be used. The clients 105, 110 typically request an IP address when their previous IP address reservation expires, or when they initialize their connection to the network. However, an IP address may be re-assigned to the client 105, 110 upon enrollment in the network-based security service. The IP address allocator 310 of the policy enforcement access point 120 receives the request and begins allocating an address to the client.

The IP address allocator 310 then requests additional credentials from the client to determine if the client should be allocated an IP address within a subnet configured to receive network-based security services. The client provides credentials to the IP address allocator (block 410). The credentials provided to the IP address allocator in the illustrated example are a username and password. However any other type of credentials could additionally or alternatively be used such as, for example, a hardware identifier such as the media access control (MAC) address of the client 105, 110. The IP address allocator 310 proceeds to look up the customer's network-based service settings from the policy database 130 (block 415). While in the illustrated example of FIG. 1 the policy database 130 is located at the policy enforcement point 125, the database 130 may be located at any other location such as the policy enforcement access point 120. Additionally or alternatively, the portion of the policy database 130 that indicates which clients are to receive the network-based services may be stored at the policy enforcement access point 120. The IP address allocator 310 then determines if the customer and/or client is to receive network-based services (block 420). If the customer is to receive services, then an IP address with a specified subnet is allocated (block 425), otherwise an IP address outside of the specified subnet is allocated (block 430).

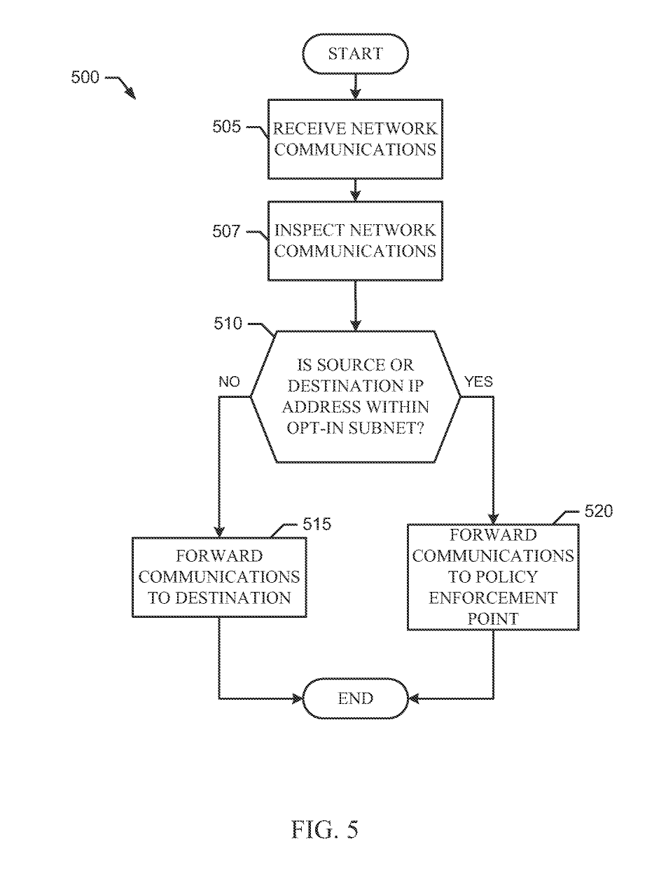

FIG. 5 is a flowchart representative of example machine-readable instructions 500 that may be executed to implement the example policy enforcement access point 120 of FIGS. 1 and 3. The example machine-readable instructions 500 begin execution when the network interface 315 of the policy enforcement access point 120 receives network communications (block 505). Upon receiving the communications, the communications forwarder 305 inspects the network communications to determine if either the source IP address or the destination IP address belong to a client that is configured to receive network-based services (e.g., the client 105) (block 507). The communications forwarder 305 determines if the network communications are destined to or coming from a client configured to receive network-based services by consulting a list of subnets that are configured to receive network-based services (block 510). If either the source 1P address or the destination IP address are within a subnet configured to receive network-based services, then the network communications is forwarded to the policy enforcement point 125 by the communications forwarder 305 (block 520). If neither the source IP address nor the destination IP address are within the subnet configured to receive network-based services, then the network communications are forwarded to the destination IP address by the communications forwarder 305 (block 515).

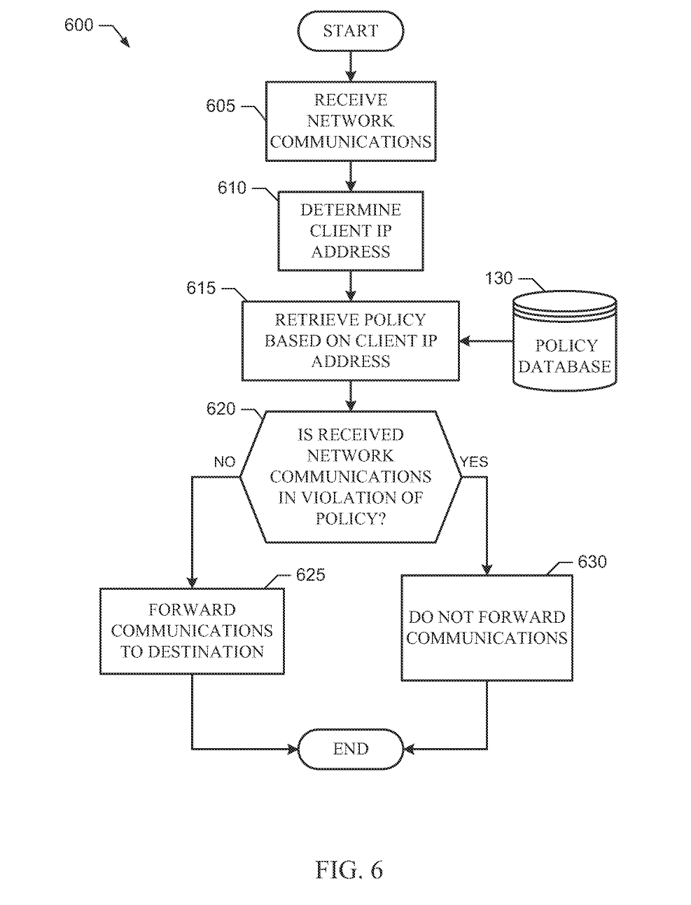

FIG. 6 is a flowchart representative of example machine-readable instructions 600 that may be executed to implement the example policy enforcement point 125 of FIGS. 1 and 2. The example machine-readable instructions 600 begin execution when the network interface 215 of the policy enforcement point 125 receives network communications (block 605). Upon receiving the communications, the communications processor 205 inspects the network communications to determine which of either the source IP address or the destination IP address belongs to a client that is configured to receive network-based services (e.g., the client 105) (block 610). For example, the client 105 may have requested content from an interne site 140 that is in violation of the policy. In such an example, the source address of the network communications is associated with the client 105. In another example, the client may have requested content from an internet site which was not in violation of a security policy (e.g., it was previously forwarded to the destination). Upon receiving the network traffic containing the response, the destination of the network communications may be the client 105.

Next, the policy applicator 210 retrieves the security policy for the client identified by block 610 (block 615) from the security policy database 130. The policy applicator 210 may perform additional translations from the IP address of the client 105 to determine the identity of customer 107 and to determine which policy(ies) to apply. Once the policy(ies) is retrieved, the policy applicator 210 compares the network communications to the security policy(ies), and determines if the network communications are in violation of the security policy(ies) (block 620). If the network communications are not in violation of the security policy(ies), the communications are forwarded to the destination IP address (block 625). If the network communications are in violation of the security policy(ies), the communications are not forwarded (block 630).

FIG. 7 is a block diagram of an example processor system or computer 700 that may execute, for example, the machine-readable instructions of FIGS. 4 through 6 to implement the example policy enforcement access point 120 of FIGS. 1 and 3, and/or the example policy enforcement point 125 of FIGS. 1 and 2. The processor system or computer 700 can be, for example, a server, a personal computer, an Internet appliance, a router, or any other type of computing device.

The system 700 of the instant example includes a processor 712. For example, the processor 712 can be implemented by one or more Intel® microprocessors from the Pentium® family, the Itanium® family or the XScale® family. Of course, other processors from other families are also appropriate.

The processor 712 is in communication with a main memory including a volatile memory 718 and a non-volatile memory 720 via a bus 722. The volatile memory 718 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 720 may be implemented by flash memory and/or any other desired type of memory device. Access to the main memory 718, 720 is typically controlled by a memory controller (not shown).

The computer 700 also includes an interface circuit 724. The interface circuit 724 may be implemented by any type of interface standard, such as an Ethernet interface, a universal serial bus (USB), and/or a PCI express interface.

One or more input devices 726 are connected to the interface circuit 724. The input device(s) 726 permit a user to enter data and commands into the processor 712. The input device(s) can be implemented by, for example, a keyboard, a mouse, a touchscreen, a track-pad, a trackball, isopoint and/or a voice recognition system.

One or more output devices 728 are also connected to the interface circuit 724. The output devices 728 can be implemented, for example, by display devices (e.g., a liquid crystal display, a cathode ray tube display (CRT), a printer and/or speakers). The interface circuit 724, thus, typically includes a graphics driver card.

The interface circuit 724 also includes a communication device such as a modem or network interface card to facilitate exchange of data with external computers via a network such as the network 115 (e.g., an Ethernet connection, a digital subscriber line (DSL), a telephone line, coaxial cable, a cellular telephone system, etc.).

The computer 700 also includes one or more mass storage devices 730 for storing software and data. Examples of such mass storage devices 730 include floppy disk drives, hard drive disks, compact disk drives and digital versatile disk (DVD) drives. The mass storage device 728 may implement the policy database 130.

The coded instructions of FIGS. 4 through 6 may be stored in the mass storage device 730, in the volatile memory 718, in the non-volatile memory 720, and/or on a removable storage medium 732, such as a CD or DVD.

Although certain example methods, apparatus and articles of manufacture have been described herein, the scope of coverage of this patent is not limited thereto. On the contrary, this patent covers all methods, apparatus, and articles of manufacture fairly falling within the scope of the claims of this patent.

1. A method to route network communications for network-based services comprising:
receiving network communications;
determining if at least one of a source address or a destination address of the received network communications is associated with a customer to receive a network-based service;
forwarding the network communications to a policy enforcement point if the at least one of the source address or the destination address is associated with the customer;
determining if the forwarded network communications violates a policy selectively associated with the customer; and
forwarding the network communications from the policy enforcement point to the destination address if the network communications is not in violation of the policy.

2. The method as described in claim 1, wherein the network-based service is security service and the policy is a security policy.

3. The method as described in claim 1, further comprising:
receiving an Internet Protocol (IP) address request from a client;
receiving credentials from the client associated with the customer;
issuing an IP address to the client, wherein the IP address is within a subnet to receive the network-based service if the credentials indicate that the client is to receive the network-based service;
issuing an IP address to the client, wherein the IP address is outside the subnet to receive the network-based service if the credentials indicate that the client is not to receive the network-based service; and
wherein determining if at least one of the source address or the destination address of the received network communications is associated with the customer to receive the network-based service further comprises determining if at least one of the source address or the destination address of the received network communications is within the subnet to receive the network-based service.

4. The method as described in claim 3, wherein the credentials indicate whether the client is to receive the network-based service when the credentials are in a list of credentials associated with customers receiving the network-based service.

5. The method as described in claim 4, wherein the list of customers receiving the network-based service is an opt-in list.

6. The method as described in claim 3, wherein the credentials comprise a username and password.

7. The method as described in claim 3, wherein the IP address is issued via a Dynamic Host Configuration Protocol.

8. The method as described in claim 1, wherein the policy is associated with the at least one of the source address or the destination address that is within the subnet.

9. The method as described in claim 1, further comprising inspecting the network communications at the policy enforcement point to determine whether the policy is applicable.

10. The method as described in claim 1, further comprising at least one of delaying or stopping the network communications if the network communications is in violation of the policy.

11. A system to route network communications for network-based services comprising:
at least one client computer associated with at least one customer; and
a policy enforcement access point to communicate with the at least one client computer and selectively forward communications of the client computer to a policy enforcement point when the customer associated with the client computer is to receive a network-based service, wherein the policy enforcement point is separate from the policy enforcement access point and to apply at least one policy selected by the customer to the communications of the client computer.

12. The system as described in claim 11, further comprising a policy database to store a list of customers to receive one or more network-based services and a list of policy configurations associated with the customers.

13. The system as described in 12, wherein the policy database is a security policy database storing security policies.

14. The system as described in claim 12, wherein the policy database is stored in a policy server.

15. The system as described in claim 12, wherein the policy database is stored in the policy enforcement point.

16. The system as described in claim 12, wherein the policy database is stored across at least two of a policy server, the policy enforcement access point, or the policy enforcement point.

17. A tangible computer-readable medium storing instructions which when executed cause a machine to:
receive network communications;
determine if at least one of a source address or a destination address of the received network communications is associated with a customer to receive a network-based service;
forward the network communications to a policy enforcement point if the at least one of the source address or the destination address is associated with the customer;
determine if the forwarded network communications violates a policy selectively associated with the customer; and
forward the network communications from the policy enforcement point to the destination address if the network communications is not in violation of the policy.

18. The tangible computer-readable medium as described in claim 17, wherein the network-based service is security service and the policy is a security policy.

19. The tangible computer-readable medium as described in claim 17, wherein the instructions when executed, further cause the machine to:
receive an Internet Protocol (IP) address request from a client associated with the customer;
receive credentials from the client;
issue an IP address to the client, wherein the IP address is within a subnet to receive the network-based service if the credentials indicate that the client is to receive the network-based service;
issue an IP address to the client, wherein the IP address is outside the subnet to receive the network-based service if the credentials indicate that the client is not to receive the network-based service; and
wherein the instructions which cause the machine to determine if at least one of the source address or the destination address of the received network communications is associated with the customer to receive the network-based service further cause the machine to determine if at least one of the source address or the destination address of the received network communications is within the subnet to receive the network-based service.

20. The tangible computer-readable medium as described in claim 19, wherein the credentials indicate whether the client is to receive the network-based service when the credentials are in a list of credentials associated with customers receiving the network-based service.

21. (canceled)

22. (canceled)

23. (canceled)

24. (canceled)

25. (canceled)

26. (canceled)
